(19) United States
(12) Patent Application Publication
(10) Pub. No.: US 2013/0320764 A1
(43) Pub. Date: Dec. 5, 2013

(54) Mobile Starting Device

(71) Applicant: Armin Zeller, Karlsruhe (DE)

(72) Inventor: Armin Zeller, Karlsruhe (DE)

(21) Appl. No.: 13/992,364

(22) PCT Filed: Dec. 5, 2011
(86) PCT No.: PCT/EP2011/071766

§ 371 Date: Aug. 15, 2013

(30) Foreign Application Priority Data
Dec. 9, 2010 (DE) 10 2010 062 708.9

(51) Int. Cl. H02J 7/34

(52) U.S. Cl. CPC H02J 7/345
USPC 307/48

(57) ABSTRACT

A mobile energy supply device for an electric starter for starting an internal combustion engine has an internal battery and at least one capacitor that is connectible in parallel to the internal battery.

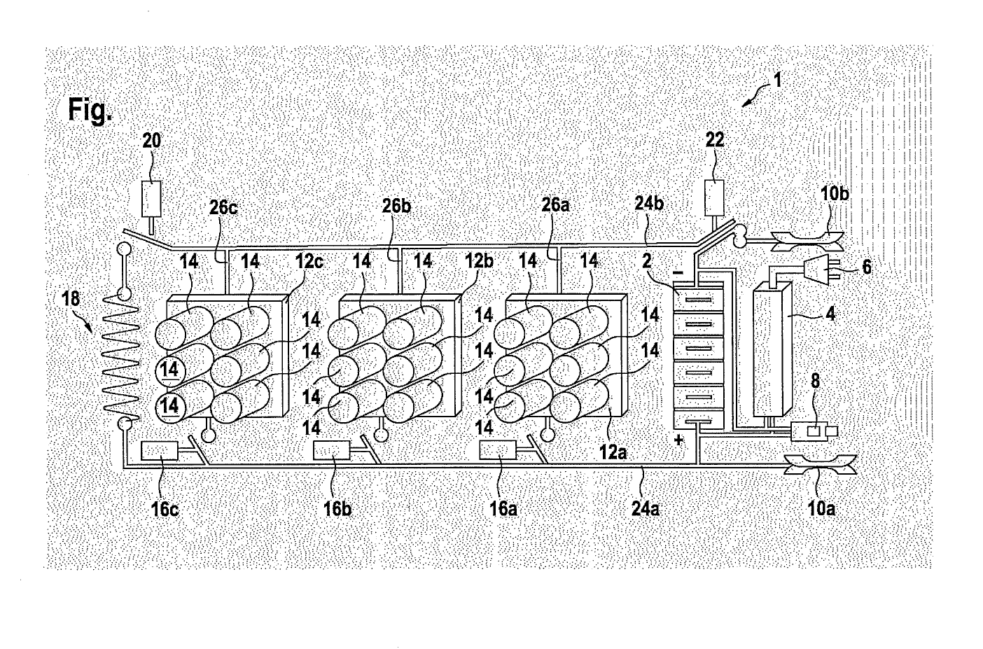

### FIELD OF THE INVENTION

The present invention relates to a mobile starting device for internal combustion engines, in particular a mobile energy supply device for an electric starter, which is provided for starting a motor vehicle, and to a method of operating an electric starter for starting an internal combustion engine.

### BACKGROUND INFORMATION

Mobile energy supply devices for vehicles are known from the related art, which contain an internal battery in a portable housing. Cables are provided in the housing in order to connect the battery electrically to the starter battery of an internal combustion engine in a motor vehicle.

In order to be able to provide the electric power required for starting the internal combustion engine, a relatively large battery providing approx. 20-40 Ah must be used. This has the consequence that the known energy supply devices have a relatively high weight of approx. 10 to 20 kg. The maximum starting power is defined by the size of the installed battery and is thus not controllable.

### SUMMARY OF THE INVENTION

An objective of the present invention is to provide a mobile energy supply device for an electric starter for starting an internal combustion engine, which is suitable for providing the required starting power according to the size of the vehicle engine and which at the same time has a low weight.

According to the present invention, this objective is achieved by an energy supply device that has a battery and at least one capacitor connectible in parallel to the battery.

The present invention also includes a method for operating an electric starter, which is provided for staring an internal combustion engine, the method including the steps:
connecting at least one capacitor in parallel to an internal battery in order to charge the capacitor by the internal battery and
electrically connecting the capacitor and the internal battery to the vehicle in order to operate the electric starter using current from the internal battery and the capacitor.

A capacitor connected in parallel to the internal battery makes it possible to distribute the high electric starting power, which is normally required only briefly during the starting process for driving the electric starter, to the internal battery and the capacitor. In this manner it is possible to provide the required electric starting power by a smaller internal battery.

Since the capacitor or capacitors has/have a significantly lower weight than a battery, the required starting power may be provided by a significantly smaller energy supply device, which has a markedly lower weight than conventional energy supply devices.

In an energy supply device according to the present invention, the at least one capacitor is connected in parallel to the internal battery and is charged by the latter, after the energy supply device has been connected to the vehicle or the starter battery of the vehicle. The energy required for operating the electric starter is then provided simultaneously by the internal battery and the capacitor. A resistor or current-limiting electronics may be provided in the circuit of the internal battery and the capacitor in order to limit the charging current of the capacitor and prevent damage to the capacitor and/or to the internal battery and/or to the electric starter by an excessively high charging current.

In one specific embodiment, the capacitor or capacitors is/are configured as multilayer capacitors or ultracap capacitors. Such capacitors have a particularly high power density and are therefore particularly suitable for providing the required electric starting power at a small device volume and a low device weight. Such capacitors therefore make it possible to implement a particularly light and compact mobile energy supply device.

In one specific embodiment, the energy supply device has multiple capacitors. Groups of capacitors are situated in multiple blocks, the blocks being selectively connectible in parallel to the internal battery. By selectively connecting the blocks it is possible to adjust the provided electric starting power in multiple stages in a targeted manner. This makes it possible to use the same energy supply device to start reliably and in a non-destructive manner both small (gasoline) engines having a small starting current requirement as well as large (diesel) engines having a very high starting current requirement. If the starting power were too low, the engine could not be started successfully. A starting power that is too high could result in the destruction of the electric starter.

In one specific embodiment, a charger for charging the internal battery is integrated into the energy supply device. This allows for the internal battery to be charged autonomously, without requiring an external charger for this purpose.

This simplifies the operation of the energy supply device and increases reliability since charging can occur independently of an additional charger. In one specific embodiment, the charger integrated into the energy supply device may also be used for charging the starter battery of the vehicle. An additional charger for charging the vehicle battery may thus be omitted.

In one specific embodiment, a protection against polarity reversal is integrated into the energy supply device, which interrupts the current flow and/or outputs a visual and/or an acoustic warning signal if the energy supply device is connected “incorrectly” to the electrical system of the vehicle, i.e. by reversed poles.

This reliably prevents damage to the energy supply device and/or to the vehicle electronics because of an incorrect polarity in the current supply. The operator is alerted to his mistake by the visual and/or acoustic indication and is able to correct it. The operability of the energy supply device is thus simplified.

In one specific embodiment, the energy supply device is equipped with an electronic circuit, which controls the charging of the internal battery and of the capacitor, the starting process, including the connection and disconnection of capacitors or groups of capacitors, and the activation of display and/or warning elements. Such an electronic circuit allows for a reliable and safe operation of the energy supply device since the operation is constantly monitored and operating errors are as much as possible eliminated or may be corrected.

In particular, it is possible reliably to prevent damage to the internal battery through overcharging or excessively discharging and through an overload due to an excessively high starting current because the electronic circuit connects the capacitors or capacitor blocks in such a way that the starting current required by the respective electric starter is reliably provided.

In one specific embodiment, the energy supply device has at least one resistor, which is connectible in parallel to the capacitor or to the capacitors in order to discharge the capacitor(s). This makes it possible to discharge the capacitors reliably and completely following the conclusion of the starting process so as to avoid reliably dangers from charged capacitors such as e.g. creeping currents, electric arcs or sparks when the device is open or damaged. This increases the safety of the energy supply device.

In one specific embodiment, the energy supply device has a display device, which displays the state of the energy supply device and in particular the charging state of the internal battery and/or of the capacitor.

The display device may include one or more LEDs, which indicate the respective operating state of the energy supply device. The operating states may be indicated for example by different color combinations. A blue LED for example may thus indicate whether the device is switched on or switched off. The state of charge of the internal battery may be indicated e.g. by one or more LEDs in the colors green, yellow and red. The selected starting power, i.e. the number of capacitors connected in parallel to the internal battery, may likewise be indicated by one or more LEDs in one or various colors.

Other displays may indicate the connection of the charger to an external current supply, a polarity reversal of the terminals, a defect in the internal battery and/or of the starter battery of the vehicle and/or the start readiness of the energy supply device.

The present invention is explained in greater detail below with reference to the appended FIGURE.

### BRIEF DESCRIPTION OF THE DRAWING

The FIGURE shows a schematic circuit diagram of an exemplary embodiment of an energy supply device 1 according to the present invention.

### DETAILED DESCRIPTION

Energy supply device 1 has an internal battery 2, which is connected to a control electronics 4, control electronics 4 having e.g. a charging circuit and being connectible via a first plug 6 to an external current supply, in particular a conventional 110-230 V outlet, in order to charge internal battery 2. Internal battery 2 is furthermore electrically connected to a second electric plug 8, which makes it possible to connect internal battery 2 electrically to a low supply voltage, in particular a 12 V electrical system of a motor vehicle.

Internal battery 2 of the exemplary embodiment shown in the FIGURE has multiple cells and is for example a conventional lead battery, as is known in the field of motor vehicle technology.

The positive pole of internal battery 2 shown at the bottom of the FIGURE is connected to a first (positive) terminal clamp 10a via a (positive) current supply line 24a. (Positive) current supply line 24a connects the positive pole of internal battery 2 also to a number of switches 16a, 16b, 16c, which in the closed state electrically connect (positive) current supply line 24a respectively to a capacitor block 12a, 12b, 12c associated with the respective switch 16a, 16b, 16c, and in the open state electrically disconnect the respective capacitor block 12a, 12b, 12c from (positive) current supply line 24a.

In the exemplary embodiment shown in the FIGURE, each capacitor block 12a, 12b, 12c has six schematically depicted capacitors 14. Capacitors 14 situated in capacitor blocks 12a, 12b, 12c may respectively have the same capacitance or different capacitances. In contrast to the exemplary embodiment shown in the FIGURE, individual capacitor blocks 12a, 12b, 12c may be equipped with a varying number of capacitors 14 so as to allow for a flexible selection of the starting power provided by energy supply device 1 over a broad range. For example, the capacitance of the individual capacitor blocks 12a, 12b, 12c may be designed in such a way that a capacitor block 12a, 12b, 12c respectively has twice the capacitance of the previous capacitor block 12a, 12b, 12c.

Capacitor blocks 12a, 12b, 12c are electrically connectible to the second (negative) pole of internal battery 2 and a second (negative) terminal clamp 10b via a second (negative) current supply line 24b and a main switch 22.

A short-circuiting switch 20 is able electrically to connect first (positive) current supply line 24a to second (negative) current supply line 24b via a resistor 18 so as to make it possible to discharge capacitors 14 in capacitor blocks 12a, 12b, 12c when switches 16a, 16b, 16c are closed.

In order to prepare the energy supply device 1 shown in the FIGURE for operation, it is connected via first electric plug 6 or second electric plug 8 to an external current source so as to charge internal battery 2. The charging of internal battery 2 is monitored and controlled by a control electronics 4.

For the purpose of a starting process, energy supply device 1 with its charged internal battery 2 is connected to the vehicle or the starter battery of the vehicle. In particular, energy supply device 1 is electrically connected by terminal clamps 10a, 10b to the electric starter, which is configured to start an internal combustion engine.

By closing main switch 22 and at least one of switches 16a, 16b, 16c, at least one of capacitor blocks 12a, 12b, 12c is connected to internal battery 2 such that capacitors 14 in capacitor blocks 12a, 12b, 12c connected to internal battery 2 are charged with current from internal battery 2. In supply lines 26a, 26b, 26c to capacitor blocks 12a, 12b, 12c, additional current limiters, not shown in the FIGURE, may be provided, for example in the form of resistors, in order to limit the charging current.

During the starting process, current flows simultaneously from internal battery 2 and capacitors 14 of connected capacitor blocks 12a, 12b, 12c through the electric starter and drives it in order to start the internal combustion engine. Because current from the capacitors of connected capacitor blocks 12a, 12b, 12c is available in addition to the current from internal battery 2, the starting current required for starting the internal combustion engine may be provided by a small and light internal battery 2.

It is also possible to connect only internal battery 2 to the vehicle or the starter battery of the vehicle if, in the case of a small internal combustion engine, the start force suffices for the vehicle or the electric starter.

Following the conclusion of the starting process, or if, following the charging of capacitors 14, no starting process is performed, capacitors 14 are discharged via resistor 18 by closing short-circuiting switch 20 in order to eliminate the danger charged capacitors 14 can pose. This occurs only when energy supply device 1 is switched off and after terminal clamps 10a, 10b have been disconnected from the starter battery.

Current supply cables 24a, 24b may have a diameter of at least 20 mm² so as to be able to provide the required starting current with as little loss as possible and to prevent thermal warming of current supply cables 24a, 24b during the starting process.

Due to the parallel connection of capacitors 14 in capacitor blocks 12a, 12b, 12c to internal battery 2, capacitors 14 are charged to the same voltage level as internal battery 2.

During the starting process, capacitors 14 support internal battery 2 in that they provide the high current required to overcome the breakaway torque of the electric starter. Capacitors 14, which are may be configured as multilayer or ultracap capacitors, are able to output the stored charge quickly in the form of a very high current.

The cascadable connection of capacitor blocks 12a, 12b, 12c, makes it possible to control and adjust the starting power because each capacitor block 12a, 12b, 12c is able to store a specific current quantity specified by the size (capacitance) and because the number of capacitors 14, and the energy quantity stored in parallel-connected capacitor blocks 12a, 12b, 12c as well as the current available during the starting process add up.

1-10. (canceled)

11. A mobile energy supply device for an electric starter for starting an internal combustion engine, comprising:
a battery; and
at least one capacitor connectible in parallel to the battery.

12. The mobile energy supply device of claim 11, wherein at least one capacitor is configured as a multilayer capacitor or an ultracap capacitor.

13. The mobile energy supply device of claim 11, wherein the energy supply device has multiple capacitors, which are arranged in multiple capacitor blocks.

14. The mobile energy supply device of claim 13, wherein the individual capacitor blocks are connectable and disconnectable in a targeted manner.

15. The mobile energy supply device of claim 11, wherein the energy supply device has a charger, which is configured for charging the battery.

16. The mobile energy supply device of claim 11, further comprising:
a resistor, which is connectible to the capacitors so that the capacitors are discharged via the resistor.

17. The mobile energy supply device of claim 11, further comprising:
a protection against polarity reversal, which is configured so as to at least one of interrupt a current flow and output an acoustic/visual warning signal if the mobile energy supply device is connected to the electric starter in reverse polarity.

18. The mobile energy supply device of claim 11, further comprising:
an electronic control circuit configured to control and monitor the operation of the energy supply device.

19. A method for operating an electric starter for starting an internal combustion engine, the method comprising:
connecting a battery to the electric starter;
connecting at least one capacitor to the battery to charge the capacitor; and
connecting the capacitor and the battery to the electric starter to drive the electric starter for starting the internal combustion engine.

20. The method of claim 19, further comprising:
discharging the capacitor via a resistor after the start of the internal combustion engine.
